(19) United States
(12) Patent Application Publication
(10) Pub. No.: US 2020/0349485 A1
(43) Pub. Date: Nov. 5, 2020

(54) OPTIMIZATION METHOD FOR JOINT SCHEDULING OF MANNED BUSES AND AUTONOMOUS BUSES

(71) Applicant: Beihang University, Beijing (CN)

(72) Inventors: Xiaolei Ma, Beijing (CN); Zhuang Dai, Beijing (CN); Xi Chen, Beijing (CN); Yanyan Chen, Beijing (CN)

(73) Assignee: Beihang University

(21) Appl. No.: 16/934,044

(22) Filed: Jul. 21, 2020

Related U.S. Application Data
(63) Continuation of application No. PCT/CN2020/085621, filed on Apr. 20, 2020.

(30) Foreign Application Priority Data
Jul. 11, 2019 (CN) 201910626011.3

(51) Int. Cl. G06Q 10/06; G08G 1/123; G01C 21/34

(52) U.S. Cl. CPC G06Q 10/06312; G06Q 10/06315; G01C 21/3446; G08G 1/123; G06Q 10/0637

(57) ABSTRACT

The present invention discloses an optimization method for joint scheduling of manned buses and autonomous buses, which fully considers the possibility of improving bus service quality and reducing operating costs using the variable capacity characteristics of autonomous buses. For passengers, the optimization method for joint scheduling dynamically adjusts the capacity and departure frequency of autonomous buses according to passenger demands, shortens passenger waiting time, and lowers the risk that a passenger cannot get on a bus during the peak period; and for bus management departments, the optimization method for joint scheduling ensures full utilization of manned buses and autonomous buses, improves scheduling efficiency, and saves operating costs by dynamically adjusting the capacity of autonomous buses during the peak period and flat peak period.

### TECHNICAL FIELD

The present invention relates to the technical field of intelligent traffic information processing, and more particularly to an optimization method for joint scheduling of manned buses and autonomous buses.

### BACKGROUND

Bus travel shows a general trend of passenger demands during the morning peak period and evening peak period, wherein the passenger demand is high during the morning peak period and evening peak period, and the passenger demand is low during the flat peak period. Under this background, the bus department faces a huge challenge in bus scheduling and management, namely how to ensure the quality of service during the peak period and flat peak period under the condition of certain operating costs, for example, by shortening the waiting time of passengers at stop, reducing crowding in buses and the like. At present, for bus scheduling, the following two methods are mainly adopted to deal with the travel of passengers during the peak period and flat peak period: (1) dividing a peak period and a flat peak period, and separately formulating timetables for scheduling buses during the peak period and the flat peak period, wherein the departure frequency of buses during the peak period is greater than that during the flat peak period; in the method, the operating cost is controlled by increasing the bus scheduling frequency during the peak period and reducing the bus scheduling frequency during the flat peak period, and the quality of service during the peak period is guaranteed to a maximum extent; however, in the method, the departure frequency during the flat peak period is reduced, inevitably prolonging the waiting time of passengers at stop during the flat peak period; (2) formulating a bus scheduling scheme in response to demands. In the method, passenger travel demands within a period of time in the future are predicted through the historical passenger demand data, bus GPS data and passenger IC card-swiping data, and a dynamic bus scheduling scheme is formulated according to the demands.

Compared with the first method, this method has more advantages in terms of controlling operating costs and improving the quality of service. However, due to the fixed bus capacity, this method may have the problem of waste of fuel consumption during the flat peak period, for example, low passenger getting-on rate, low effective utilization rate of buses, or the like; and during the peak period, due to the fixed bus capacity, passengers may face a risk of not getting on a bus.

With the development of technologies such as vehicle sensing, artificial intelligence and Internet of Vehicles, an autonomous bus has the unique advantages in further improving the demand responsiveness and scheduling flexibility of urban bus systems. The existing research points out that autonomous buses can improve road driving safety, reduce the total fuel consumption of bus systems, reduce human resource costs of drivers, and optimize the bus travel time to reduce bus bunching. In addition, by connecting or assembling autonomous bus units with small capacity, dynamic adjustment of the bus capacity of autonomous buses can be realized, for example, a plurality of autonomous bus units are assembled together during the peak period, to form a fleet of buses, thereby increasing the bus capacity and reducing the waiting time of passengers at stop; and during the flat peak period, the autonomous bus units are separately scheduled, so the operating cost is reduced under the condition of not reducing the bus departure frequency finally. Therefore, for the bus management department, the quality of service can be improved by optimizing the departure frequency of buses, and the operating cost can be further reduced by optimizing the capacity of autonomous buses.

Meanwhile, the fully autonomous driving technology is predicted to take a long time to fully occupy the market due to the problems of immature technology, safety and government regulations. Within a period of time in the future, there is a greater possibility of coexistence of manned buses and autonomous buses.

Therefore, how to efficiently schedule manned buses and autonomous buses to improve the quality of service and reduce operating costs is a problem to be urgently solved by those skilled in the art.

### SUMMARY

In view of this, the present invention provides an optimization method for joint scheduling of manned buses and autonomous buses, which ensures the full utilization of manned buses and autonomous buses, improves the quality of service, and saves the operating costs.

To achieve the above purpose, the present invention adopts the following technical solution:

An optimization method for joint scheduling of manned buses and autonomous buses, comprising:

step 1: discretizing a scheduling cycle into uniformly distributed time nodes, and setting a decision variable, wherein the decision variable represents the departure type at different time nodes;

step 2: based on the departure number, the bus departure time, the passenger getting-on/off time, the boarding demand, the actual boarding number, the number of passengers getting off, the number of passengers delaying at stop, and the number of passengers on the bus, building a bus running simulation model;

step 3: setting an operating cost function of the manned buses and the autonomous buses;

step 4: determining a passenger waiting time cost;

step 5: based on the operating cost function and the passenger waiting time cost, building an optimization model for joint scheduling of manned buses and autonomous buses; and

step 6: solving the optimization model to obtain a joint scheduling scheme for manned buses and autonomous buses.

Preferably, the step 1 specifically includes:

discretizing a scheduling cycle T into nₖ+1 uniformly distributed time nodes, and expressing the discretized time nodes as κ=[0,1, . . . , nₖ], so the unit discrete time duration is δ=T/nₖ;

the decision variable xₘₖ represents the departure type at different time nodes, xₘₖ is a variable of 0-1, indicating whether to dispatch a bus of type m at the time node k.

Preferably, the step 2 specifically includes:

according to bus dispatches at discretized time points, obtaining that the total departure number of buses is

$$n = {\sum }_{k ∈ κ} {\sum }_{m ∈ M} {x}_{m k} \qquad ( 1 )$$

wherein at each time node, at most one bus departs from the stop, and the total departure number of buses does not exceed the number of existing buses:

$$\begin{matrix}{\sum }_{m ∈ M} {x}_{m k} \leq 1 k = 0 , … , {n}_{k} & ( 2 ) \\ {\sum }_{k ∈ κ} {\sum }_{m ∈ {M}_{a}} m {x}_{m k} \leq {N}_{a} & ( 3 ) \\ {\sum }_{k ∈ κ} {x}_{0 k} \leq {N}_{0} & ( 4 )\end{matrix}$$

where N₀ represents the number of the existing manned buses, and Nₐ represents the number of the existing autonomous buses;

according to the decision variable xₘₖ, obtaining the departure time d_{v,1} and departure type θᵥ, of all buses as follows:

$$\begin{matrix}{d}_{v , 1} = δ min \{ k \vert {\sum }_{t \leq k} {\sum }_{m ∈ M} {x}_{mt} = v , k ∈ κ \} v = 1 , … , n v = 1 , 2 , & ( 5 ) \\ {θ}_{v} = {\sum }_{m ∈ M} m {x}_{{mk}_{v}} v = 1 , … , n & ( 6 )\end{matrix}$$

where δ represents the unit time duration after the discretized time;

the time interval between two consecutive buses departing from the initial stop is not less than h₀:

d_{v,1}−d_{v-1,1}≥h₀ v=2, . . . , n (7)

assuming that the travel time of the bus v at a stop s and a stop s+1 is t_{v,s}, the departure time at the stop s is d_{v,s}, and the passenger getting-on/off time is u_{v,s}, expressing the departure time of the bus at the stop as the departure time of the bus at the previous stop plus the travel time of the bus between the two stops, plus the passenger getting-on/off time when the bus arrives at the current stop:

d_{v,s}=d_{v,s-1}+t_{v,s-1}+u_{v,s} v=1, . . . , n; s=2, . . . , nₛ (8)

where nₛ represents the number of stops of bus routes;

for the bus system, if passengers get on and off at the same time through the front and rear doors of the bus, the passenger getting-on/off time is the maximum time consumed for passengers to get on and off:

u_{v,s}=max(τ_{b}β̅_{v,s},τₐα_{v,s}) v=1, . . . , n; s=1, . . . , nₛ (9)

where τ_{b} and τₐ respectively represent the average time consumed for one passenger to get on and off, β̅_{v,s} represents the actual boarding number, and α_{v,s} represents the number of passengers getting off;

the boarding demand β_{v,s} includes passengers who arrive at the stop during bus running and passengers ω_{v-1,s} is who cannot get on because the previous bus is full,

β_{v,s}=ω_{v-1,s}+λₛ(d_{v,s}−d_{v-1,s}) v=1, . . . , n; s=1, . . . , nₛ−1 (10)

where λₛ represents the passenger arrival rate at the stop s, and d_{v,s}−d_{v-1,s} represents the time headway of the bus v at the stop s;

due to the limitation of the capacity of the bus, the actual boarding number β̅_{v,s} cannot exceed the available capacity of the bus, i.e.

β̅_{v,s}=min(β_{v,s},c_{θ}_{ᵥ}−l_{v,s}+α_{v,s}) v=1, . . . , n; s=1, . . . , nₛ−1 (11)

where c_{θ}_{ᵥ}−l_{v,s}+α_{v,s} represents the remaining available capacity of the bus v, c_{θ}_{ᵥ},l_{v,s} and α_{v,s} respectively represent the maximum passenger capacity of the bus v, the passenger number when the bus just arrives at the stop s and the number of passengers getting off the bus at the stop s;

the difference between the boarding demand β_{v,s} and the actual boarding number β̅_{v,s} is the number of passengers left at the stop s by the bus v:

ω_{v,s}=β_{v,s}−β̅_{v,s}, v=1, . . . , n; s=1, . . . , nₛ−1 (12)

according to the historical statistics of the number of passengers getting off the bus at all stops, obtaining that the ratio of the number of passengers getting off the bus v at the stop s to the actual number of passengers on the bus is ρₛ, so the number of passengers getting off the bus v at the stop s is:

α_{v,s}=ρₛl_{v,s} v=1, . . . , n; s=2, . . . , nₛ (13)

finally, obtaining that the passenger number l_{v,s} when the bus v arrives at the stop s is equal to the passenger number when the bus arrives at the previous stop plus the actual number of passengers getting on the bus at the previous stop, minus the number of passengers getting off the bus at the previous stop, i.e.

$${l}_{v , s} = \{ \begin{matrix}0 & s = 1 \\ {l}_{v , s - 1} + {\overline{β}}_{v , s - 1} - {α}_{ν , s - 1} & s = 2 , … , {n}_{s}\end{matrix} \\ v = {n}_{v} + 1 , … , {n}_{v} + {n}_{T} + 1 \qquad ( 14 )$$

where l_{v,1}=0 indicates that the initial number of passengers on the bus is 0.

Preferably, the step 3 specifically includes:

the operating cost of all types of buses is:

$${f}_{m} = \{ \begin{matrix}{C}_{0}^{F} + {C}_{0}^{V} \cdot {c}_{0} & m = 0 \\ {C}_{a}^{F} + {C}_{a}^{V} \cdot ( mc ) + {C}_{a}^{A} & m = 1 , … , a\end{matrix} \qquad ( 15 )$$

wherein for a manned bus, the operating cost is expressed as f₀=C₀^{F}+C₀^{V}·c₀, where c₀ represents the capacity of the manned bus, and C₀^{F} and C₀^{V} represent the fixed operating cost and marginal operating cost of the manned bus, respectively; and

for an autonomous bus, the operating cost is expressed as fₘ=Cₐ^{F}+Cₐ^{V}·(mc)+Cₐ^{A}, where mc represents the capacity of the autonomous bus of type m, and Cₐ^{F} and Cₐ^{V} represent the fixed operating cost and marginal operating cost of the autonomous bus, respectively.

Preferably, in the step 4, the passenger waiting time includes two parts, one part is the time for passengers to wait for a bus which arrives at the stop first after he/she arrives at the stop, and the other part is the further waiting time for passengers who cannot get on the bus due to the limitation of bus capacity; for the first part, assuming that passengers arrive at random, the average waiting time of the passengers is half of the time headway, i.e. ½(d_{v,s}−d_{v-1,s}), and the total arrival number of passengers is λₛ (d_{v,s}−d_{v-1,s}), the waiting time of passengers at this stop when the bus v arrives at the stop s is ½λₛ(d_{v,s}−d_{v-1,s})²; and for the second part, the passenger waiting time is the product of the stranded passenger number ω_{v,s} and the time headway.

Preferably, in the step 5, the optimization model is:

$$min z = {\sum }_{k ∈ κ} {\sum }_{m ∈ M} {x}_{mk} {f}_{m} + {ρ}_{1} {\cdot \sum }_{v = 1}^{n} {\sum }_{s = 1}^{{n}_{s} - 1} [ \frac{1}{2} {{λ}_{s} ( {d}_{v , s} - {d}_{v - 1 , s} )}^{2} ] + {ρ}_{2} {\cdot \sum }_{v = 1}^{n} {\sum }_{s = 1}^{{n}_{s} - 1} {ω}_{v , s} ( {d}_{v + 1 , s} - {d}_{v , s} ) \\ s . t . \\ Eqs . ( 1 ) \text{-} ( 15 ) \qquad ( 16 )$$

where ρ₁ and ρ₂ respectively represent the cost parameters corresponding to the waiting time of the two parts.

Preferably, the optimization model is a nonlinear shaping optimization model, and is directly solved by business optimization software Cplex or gurobi.

It can be known from the above technical solution that compared with the prior art, the present invention discloses and provides an optimization method for joint scheduling of manned buses and autonomous buses, which has the following advantages:

1. In the present invention, the influence of the variable capacity design of autonomous buses on the traditional bus scheduling is fully considered, so operating costs of management departments can be reduced by adjusting the bus capacity without reducing the bus departure frequency.

2. In the present invention, scheduling cycle time is discretized, and a decision variable is set as the departure type of each time node. The modeling method realizes the joint scheduling of manned buses and autonomous buses, and optimizes the bus departure frequency and bus capacity simultaneously according to passenger demands. The obtained scheduling scheme is extremely flexible, and is suitable for the flexible scheduling demands of modern high-capacity bus systems.

3. In the present invention, manned buses and autonomous buses are abstracted into different bus types, which can be characterized by the same decision variable, the optimization model is simplified, and the calculation efficiency is improved, so the present invention can be better applied to the modeling and optimization of realistic and complex bus scheduling systems.

### DESCRIPTION OF DRAWINGS

To more clearly describe the technical solution in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is a flow chart showing an optimization method for joint scheduling of manned buses and autonomous buses provided by the present invention.

FIG. 2 is a schematic diagram showing an optimization method for joint scheduling of manned buses and autonomous buses provided by the present invention.

### DETAILED DESCRIPTION

The technical solution in the embodiments of the present invention will be clearly and fully described below in combination with the drawings in the embodiments of the present invention. Apparently, the described embodiments are merely part of the embodiments of the present invention, not all of the embodiments.

Based on the embodiments in the present invention, all other embodiments obtained by those ordinary skilled in the art without contributing creative labor will belong to the protection scope of the present invention.

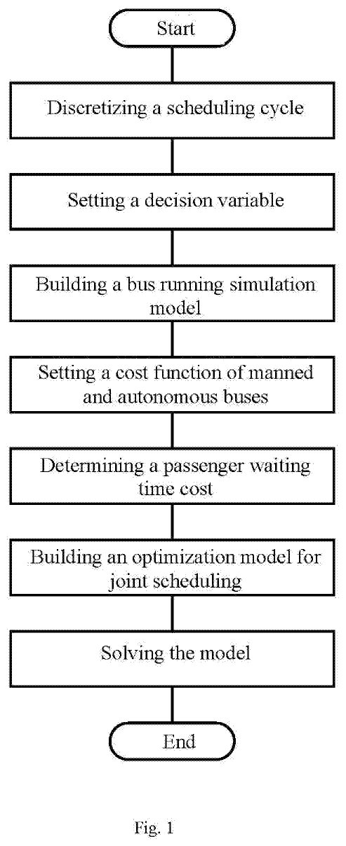

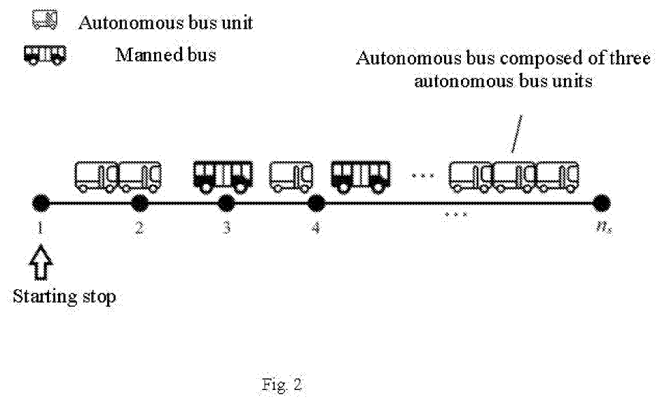

As shown in FIG. 1 and FIG. 2, embodiments of the present invention disclose an optimization method for joint scheduling of manned buses and autonomous buses, comprising:

step 1: discretizing a scheduling cycle into uniformly distributed time nodes, and setting a decision variable, wherein the decision variable represents the departure type at different time nodes;

step 2: based on the departure number, the bus departure time, the passenger getting-on/off time, the boarding demand, the actual boarding number, the number of passengers getting off, the number of passengers delaying at stop, and the number of passengers on the bus, building a bus running simulation model;

step 3: setting an operating cost function of the manned buses and the autonomous buses;

step 4: determining a passenger waiting time cost;

step 5: based on the operating cost function and the passenger waiting time cost, building an optimization model for joint scheduling of manned buses and autonomous buses; and

step 6: solving the optimization model to obtain a joint scheduling scheme for manned buses and autonomous buses.

It should be noted here that the execution order of the step 3 and step 4 is not limited, as long as it is completed before the step 5 is executed.

To further optimize the above technical solution, the step 1 specifically includes:

discretizing a scheduling cycle T into nₖ+1 uniformly distributed time nodes, and expressing the discretized time nodes are expressed as κ=[0,1, . . . , nₖ], so the unit discrete time duration is δ=T/nₖ;

the decision variable xₘₖ represents the departure type at different time nodes, xₘₖ represents a variable of 0-1, indicating whether to dispatch a bus of type m at the time node k.

To further optimize the above technical solution, the step 2 specifically includes:

according to bus dispatches at discretized time points, obtaining that the total departure number of buses is

$$n = {\sum }_{k ∈ κ} {\sum }_{m ∈ M} {x}_{m k} \qquad ( 1 )$$

wherein at each time node, at most one bus departs from the stop, and the total departure number of buses does not exceed the number of existing buses:

$$\begin{matrix}{\sum }_{m ∈ M} {x}_{m k} \leq 1 k = 0 , … , {n}_{k} & ( 2 ) \\ {\sum }_{k ∈ κ} {\sum }_{m ∈ {M}_{a}} m {x}_{m k} \leq {N}_{a} & ( 3 ) \\ {\sum }_{k ∈ κ} {x}_{0 k} \leq {N}_{0} & ( 4 )\end{matrix}$$

where N₀ represents the number of the existing manned buses, and Nₐ represents the number of the existing autonomous buses;

according to the decision variable xₘₖ, obtaining the departure time d_{v,1} and departure type θ_{y} of all buses as follows:

$$\begin{matrix}{d}_{v , 1} = δ min \{ k \vert {\sum }_{t \leq k} {\sum }_{m ∈ M} {x}_{m t} = v , k ∈ κ \} v = 1 , … n v = 1 , 2 , & ( 5 ) \\ {θ}_{v} = {\sum }_{m ∈ M} m {x}_{m {k}_{v}} v = 1 , … , n & ( 6 )\end{matrix}$$

where δ represents the unit time duration after the discretized time;

for the bus v, the serial number of the bus in front of it is v−1; in order to ensure the bus scheduling safety, the minimum departure time interval is set to h₀, and h₀ can be set according to the road characteristics of the bus routes and passenger demands, so that the time interval between two consecutive buses departing from the initial stop is not less than h₀:

d_{v,1}−d_{v-1,1}≥h₀ v=2, . . . , n (7)

assuming that the travel time of the bus v at a stop s and a stop s+1 is t_{v,s}, the departure time at the stop s is d_{v,s}, and the passenger getting-on/off time is u_{v,s}, expressing the departure time of the bus at the stop as the departure time of the bus at the previous stop plus the travel time of the bus between the two stops, plus the passenger getting-on/off time when the bus arrives at the current stop:

d_{v,s}=d_{v,s-1}+t_{v,s-1}+u_{v,s} v=1, . . . , n; s=2, . . . , nₛ (8)

where nₛ represents the number of stops of bus routes;

for the bus system, if passengers get on and off at the same time through the front and rear doors of the bus, the passenger getting-on/off time is the maximum time consumed for passengers to get on and off:

u_{v,s}=max(τ_{b}β̅_{v,s},τₐα_{v,s}) v=1, . . . , n; s=1, . . . , nₛ (9)

where τ_{b} and τₐ respectively represent the average time consumed for one passenger to get on and off, β̅_{v,s} represents the actual boarding number, and α_{v,s} represents the number of passengers getting off;

the boarding demand β_{v,s} includes passengers who arrive at the stop during bus running and passengers ω_{v-1,s} who cannot get on the bus because the previous bus is full,

β_{v,s}=ω_{v-1,s}+λₛ(d_{v,s}−d_{v-1,s}) v=1, . . . , n; s=1, . . . , nₛ−1 (10)

where λₛ represents the passenger arrival rate at the stop s, and d_{v,s}−d_{v-1,s} represents the time headway of the bus v at the stop s;

due to the limitation of the capacity of the bus, the actual boarding number β̅_{v,s} cannot exceed the available capacity of the bus, i.e.

β̅_{v,s}=min(β_{v,s},c_{θ}_{ᵥ}−l_{v,s}+α_{v,s}) v=1, . . . , n; s=1, . . . , nₛ−1 (11)

where c_{θ}_{ᵥ}−l_{v,s}+α_{v,s} represents the remaining available capacity of the bus v, c_{θ}_{ᵥ},l_{v,s} and α_{v,s} and as respectively represent the maximum passenger capacity of the bus v, the passenger number when the bus just arrives at the stop s and the number of passengers getting off the bus at the stop s;

the difference between the boarding demand β_{v,s} and the actual boarding number β̅_{v,s} is the number of passengers left at the stop s by the bus v:

ω_{v,s}=β_{v,s}−β̅_{v,s}, v=1, . . . , n; s=1, . . . , nₛ−1 (12)

according to the historical statistics of the number of passengers getting off the bus at all stops, obtaining that the ratio of the number of passengers getting off the bus v at the stop s to the actual number of passengers on the bus is ρ_{S}, so the number of passengers getting off the bus v at the stop s is

α_{v,s}=ρₛl_{v,s} v=1, . . . , n; s=2, . . . , nₛ (13)

finally, obtaining that the passenger number l_{v,s} when the bus s v arrives at the stop s is equal to the passenger number when the bus arrives at the previous stop plus the actual number of passengers getting on the bus at the previous stop, minus the number of passengers getting off the bus at the previous stop, i.e.

$${l}_{v , s} = \{ \begin{matrix}0 & s = 1 \\ {l}_{v , s - 1} + {\overline{β}}_{v , s - 1} - {α}_{v , s - 1} & s = 2 , … , {n}_{s}\end{matrix} \\ v = {n}_{v} + 1 , … , {n}_{v} + {n}_{T} + 1 \qquad ( 14 )$$

where l_{v,1}=0 indicates that the initial number of passengers on the bus is 0; since formulas (1) to (14) are recursive in sequence, the running process and the passenger number of all buses within the scheduling cycle are obtained, and the bus operating cost and passenger waiting time cost are calculated accordingly.

To further optimize the above technical solution, the step 3 specifically includes:

the operating cost of all types of buses is:

$${f}_{m} = \{ \begin{matrix}{C}_{0}^{F} + {C}_{0}^{V} \cdot {c}_{0} & m = 0 \\ {C}_{a}^{F} + {C}_{a}^{V} \cdot ( mc ) + {C}_{a}^{A} & m = 1 , … , a\end{matrix} \qquad ( 15 )$$

wherein for a manned bus, the operating cost is expressed as f₀=C₀^{F}+C₀^{V}·c₀, where c₀ represents the capacity of the manned bus, and C₀^{F} and C₀^{V} represent the fixed operating cost and marginal operating cost of the manned bus, respectively; and

for an autonomous bus, the operating cost is expressed as fₘ=Cₐ^{F}+Cₐ^{V}·(mc)+Cₐ^{A}, where mc represents the capacity of the autonomous bus of type m, and Cₐ^{F} and Cₐ^{V} represent the fixed operating cost and marginal operating cost of the autonomous bus, respectively.

To further optimize the above technical solution, in the step 4, the passenger waiting time includes two parts, one part is the time for passengers to wait for a bus which arrives at the stop first after he/she arrives at the stop, and the other part is the further waiting time for passengers who cannot get on the bus due to the limitation of bus capacity; for the first part, assuming that passengers arrive at random, the average waiting time of the passengers is half of the time headway, i.e. ½(d_{v,s}−d_{v-1,s}), and the total arrival number of passengers is λₛ (d_{v,s}−d_{v-1,s}), the waiting time of passengers at this stop when the bus v arrives at the stop s ½λₛ(d_{v,s}−d_{v-1,s})²; and for the second part, the passenger waiting time is the product of the stranded passenger number ω_{v,s} and the time headway.

To further optimize the above technical solution, in the step 5, the optimization model is:

$$min z = {\sum }_{k ∈ κ} {\sum }_{m ∈ M} {x}_{m k} {f}_{m} + {ρ}_{1} \cdot {\sum }_{v = 1}^{n} {\sum }_{s = 1}^{{n}_{s} - 1} [ \frac{1}{2} {{λ}_{s} ( {d}_{v , s} - {d}_{v - 1 , s} )}^{2} ] + {ρ}_{2} \cdot {\sum }_{v = 1}^{n} {\sum }_{s = 1}^{{n}_{s} - 1} {ω}_{v , s} ( {d}_{v + 1 , s} - {d}_{v , s} ) \\ s . t . \\ Eqs . ( 1 ) \text{-} ( 15 ) \qquad ( 16 )$$

where ρ₁ and ρ₂ respectively represent the cost parameters corresponding to the waiting time of the two parts.

To further optimize the above technical solution, the optimization model is a nonlinear shaping optimization model, and is directly solved by business optimization software Cplex or gurobi.

In the optimization method for joint scheduling of manned buses and autonomous buses provided by the present invention, an available bus type is determined first, wherein the bus type of a manned bus is 0, and the capacity thereof is c; the capacity of an autonomous bus is adjusted by assembling (or disassembling) autonomous bus units, an autonomous bus type 1, 2, . . . , a is obtained, where the bus type a represents an autonomous bus which is obtained by assembling a autonomous bus units and has a capacity of ac, where c represents an autonomous bus unit passenger capacity; the available bus type is expressed as m∈M=[−1,0,1,2, . . . , a], where m=−1 represents the case of no departure, m=0 represents the case of departure of manned buses, and m>0 represents the case of departure of autonomous buses. Further, the bus scheduling cycle time is discretized (for example every minute). Assuming that the decision variable represents the departure type at the first time node, by optimizing the decision variable, dynamic adjustment of the bus departure frequency and bus capacity is realized, the joint scheduling of manned buses and autonomous buses is realized at the same time, and the objective function is optimized as the sum of the bus operating cost and the passenger cost, wherein the passenger cost is the passenger waiting time cost.

Based on the development situation of autonomous buses, the technical solution provided by the present invention analyzes the influence thereof on existing bus scheduling, and fully considers the possibility of improving bus service quality and reducing operating costs using the variable capacity characteristics of autonomous buses. For passengers, the optimization method for joint scheduling dynamically adjusts the capacity and departure frequency of autonomous buses according to passenger demands, shortens passenger waiting time, and lowers the risk that a passenger cannot get on a bus during the peak period; and for the bus management departments, the optimization method for joint scheduling ensures full utilization of manned buses and autonomous buses, improves scheduling efficiency, and saves operating costs by dynamically adjusting the capacity of automatic driven buses during peak period and flat peak period.

The optimization method for joint scheduling of manned buses and autonomous buses of the present invention is described below in conjunction with a simulation example. A simulation bus route includes 10 bus stops, the distance between every two stops is 500 m, and the running time of a bus between stops follows a lognormal distribution (lognormal), wherein the average time is 1 minute and the variance coefficient of variation is 0.4. The following two simulation scenarios are taken into consideration.

Scenario 1: traditional bus scheduling based on manned buses. Assuming that the system has 4 manned buses each having a capacity of 45 seats, 180 seats in total; the fixed cost of manned buses is 350 Yuan/shift, and the marginal cost is 4 Yuan/shift, the operating cost of manned buses is 530 Yuan/shift according to the cost function (15).

Scenario 2: joint scheduling of manned buses and autonomous buses. Assuming that the system has 2 manned buses each having a capacity of 45 seats, and 5 autonomous bus units each having a capacity of 6 seats, the manned buses and autonomous buses have 180 seats in total. Based on driving safety, assuming that the autonomous buses can be assembled with up to 5 autonomous bus units, the available bus types of the autonomous buses include: type 1 (6 seats/bus), type 2 (12 seats/bus), type 3 (18 seats/bus), type 4 (24 seats/bus) and type 5 (30 seats/bus). Since the autonomous bus requires no driver intervention, assuming that the fixed cost of autonomous buses is 130 Yuan/shift, and the marginal cost is 4 Yuan/seat, the operating costs of the five types of autonomous buses are 154 Yuan/shift, 178 Yuan/shift, 202 Yuan/shift, 226 Yuan/shift and 250 Yuan/shift respectively.

Passenger waiting time cost parameters ρ₁=5 Yuan/minute, ρ₂=7 Yuan/minute.

In scenario 1, the departure frequency is 5 minutes/shift, which ensures that all buses can be fully utilized; and in scenario 2, the departure frequency and the departure type are taken from the calculation results of the optimization model (16); and the model (16) is optimized using Cplex software. 20 simulations are performed, each simulation is performed for 5 hours, and the average of results of 20 simulations is taken as the final result. Simulation results are shown in Table 1.

TABLE 1
Simulation Results

| | Operating Cost | Passenger Cost | Average Passenger Waiting |
|---|---|---|---|
| | (Yuan) | (Yuan) | Time (Minute) |
| Scenario 1 | 25248 | 63588 | 3.23 |
| Scenario 2 | 23483 | 54110 | 2.55 |
| Model | 7.0% | 14.9% | 21.1% |
| Promotion | | | |

In the present invention, joint scheduling is performed on manned buses and autonomous buses, and joint optimization is performed on departure frequency and bus capacity. Compared with the traditional manned bus-based scheduling, the method can effectively reduce the bus operating cost (reduced by 7.0%) and passenger waiting time cost (reduced by 14.9%), and reduce the average passenger waiting time (reduced by 21.1%) at the same time.

Each embodiment in the description is described in a progressive way. The difference of each embodiment from each other is the focus of explanation. The same and similar parts among all of the embodiments can be referred to each other. For the device disclosed by the embodiments, because the device corresponds to a method disclosed by the embodiments, the device is simply described. Refer to the description of the method part for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

1. An optimization method for joint scheduling of manned buses and autonomous buses, comprising:
step 1: discretizing a scheduling cycle into uniformly distributed time nodes, and setting a decision variable, wherein the decision variable represents the departure type at different time nodes;
step 2: based on the departure number, the bus departure time, the passenger getting-on/off time, the boarding demand, the actual boarding number, the number of passengers getting off, the number of passengers delaying at stop, and the number of passengers on the bus, building a bus running simulation model;
step 3: setting an operating cost function of the manned buses and the autonomous buses;
step 4: determining a passenger waiting time cost;
step 5: based on the operating cost function and the passenger waiting time cost, building an optimization model for joint scheduling of manned buses and autonomous buses; and
step 6: solving the optimization model to obtain a joint scheduling scheme for manned buses and autonomous buses.

2. The optimization method for joint scheduling of manned buses and autonomous buses according to claim 1, wherein the step 1 specifically includes:
discretizing a scheduling cycle T into nₖ+1 uniformly distributed time nodes, and expressing the discretized time nodes as κ=[0,1, . . . , nₖ], so the unit discrete time duration is δ=T/nₖ;
the decision variable xₘₖ represents the departure type at different time nodes, and xₘₖ represents a variable of 0-1, indicating whether to dispatch a bus of type m at the time node k.

3. The optimization method for joint scheduling of manned buses and autonomous buses according to claim 2, wherein the step 2 specifically includes:
according to bus dispatches at discretized time points, obtaining that the total departure number of buses is
$$n = {\sum }_{k ∈ κ} {\sum }_{m ∈ M} {x}_{m k} \qquad ( 1 )$$
wherein at each time node, at most one bus departs from the stop, and the total departure number of buses does not exceed the number of the existing buses:
$$\begin{matrix}{\sum }_{m ∈ M} {x}_{m k} \leq 1 k = 0 , … , {n}_{k} & ( 2 ) \\ {\sum }_{k ∈ κ} {\sum }_{m ∈ {M}_{a}} m {x}_{m k} \leq {N}_{a} & ( 3 ) \\ {\sum }_{k ∈ κ} {x}_{0 k} \leq {N}_{0} & ( 4 )\end{matrix}$$
where N₀ represents the number of the existing manned buses, and Nₐ represents the number of the existing autonomous buses;
according to the decision variable xₘₖ, obtaining the departure time d_{v,1} and departure type θᵥ of all buses as follows:
$$\begin{matrix}{d}_{v , 1} = δ min \{ k \vert {\sum }_{t \leq k} {\sum }_{m ∈ M} {x}_{m t} = v , k ∈ κ \} v = 1 , … n v = 1 , 2 , & ( 5 ) \\ {θ}_{v} = {\sum }_{m ∈ M} m {x}_{m {k}_{v}} v = 1 , … , n & ( 6 )\end{matrix}$$
where δ represents the unit time duration after the discretized time;
the time interval between two consecutive buses departing from the initial stop is not less than h₀:
d_{v,1}−d_{v-1,1}≥h₀ v=2, . . . , n (7)
assuming that the travel time of the bus v between a stop s and a stop s+1 is t_{v,s}, the departure time at the stop s is d_{v,s}, and the passenger getting-on/off time is u_{v,s}, expressing the departure time of the bus at the stop as the departure time of the bus at the previous stop plus the travel time of the bus between the two stops, plus the passenger getting-on/off time when the bus arrives at the current stop:
d_{v,s}=d_{v,s-1}+t_{v,s-1}+u_{v,s} v=1, . . . , n; s=2, . . . , nₛ (8)
where nₛ represents the number of stops of bus routes;
for the bus system, if passengers get on and off at the same time through the front and rear doors of the bus, the passenger getting-on/off time is the maximum time consumed for passengers to get on and off:
u_{v,s}=max(τ_{b}β̅_{v,s},τₐα_{v,s}) v=1, . . . , n; s=1, . . . , nₛ (9)
where τ_{b} and τₐ respectively represent the average time consumed for one passenger to get on and off, β̅_{v,s} represents the actual boarding number, and α_{v,s} represents the number of passengers getting off;
the boarding demand β_{v,s} includes passengers who arrive at the stop during bus running and passengers ω_{v-1,s} who cannot get on because the previous bus is full,
β_{v,s}=ω_{v-1,s}+λₛ(d_{v,s}−d_{v-1,s}) v=1, . . . , n; s=1, . . . , nₛ−1 (10)
where λₛ represents the passenger arrival rate at the stop s, and d_{v,s}−d_{v-1,s} represents the time headway of the bus v at the stop s;
due to the limitation of the capacity of the bus, the actual boarding number β̅_{v,s} cannot exceed the available capacity of the bus, i.e.
β̅_{v,s}=min(β_{v,s},c_{θ}_{ᵥ}−l_{v,s}+α_{v,s}) v=1, . . . , n; s=1, . . . , nₛ−1 (11)
where c_{θ}_{ᵥ}−l_{v,s}+α_{v,s} represents the remaining available capacity of the bus v, c_{θ}_{ᵥ},l_{v,s} and α_{v,s} respectively represent the maximum passenger capacity of the bus v, the passenger number when the bus just arrives at the stop s and the number of passengers getting off the bus at the stop s;
the difference between the boarding demand β_{v,s} and the actual boarding number β̅_{v,s} is the number of passengers left at the stop s by the bus v:
ω_{v,s}=β_{v,s}−β̅_{v,s}, v=1, . . . , n; s=1, . . . , nₛ−1 (12)
according to the historical statistics of the number of passengers getting off the bus at all stops, obtaining that the ratio of the number of passengers getting off the bus v at the stop s to the actual number of passengers on the bus is ρₛ, so the number of passengers getting off the bus v at the stop s is:
α_{v,s}=ρₛl_{v,s} v=1, . . . , n; s=2, . . . , nₛ (13)
finally, obtaining that the passenger number l_{v,s} when the bus v arrives at the stop s is equal to the passenger number when the bus arrives at the previous stop plus the actual boarding number the bus at the previous stop, minus the number of passengers getting off the bus at the previous stop, i.e.
$${l}_{v , s} = \{ \begin{matrix}0 & s = 1 \\ {l}_{v , s - 1} + {\overline{β}}_{v , s - 1} - {α}_{v , s - 1} & s = 2 , … , {n}_{s}\end{matrix} \\ v = {n}_{v} + 1 , … , {n}_{v} + {n}_{T} + 1 \qquad ( 14 )$$
where l_{v,1}=0 indicates that the initial number of passengers on the bus is 0.

4. The optimization method for joint scheduling of manned buses and autonomous buses according to claim 3, wherein the step 3 specifically includes:
the operating cost of all types of buses is:
$${f}_{m} = \{ \begin{matrix}{C}_{0}^{F} + {C}_{0}^{V} \cdot {c}_{0} & m = 0 \\ {C}_{a}^{F} + {C}_{a}^{V} \cdot ( mc ) + {C}_{a}^{A} & m = 1 , … , a\end{matrix} \qquad ( 15 )$$
wherein for a manned bus, the operating cost is expressed as f₀=C₀^{F}+C₀^{V}·c₀, where c₀ represents the capacity of the manned bus, and C₀^{F} and C₀^{V} represent the fixed operating cost and marginal operating cost of the manned bus, respectively; and
for an autonomous bus, the operating cost is expressed as fₘ=Cₐ^{F}+Cₐ^{V}·(mc)+Cₐ^{A}, where mc represents the capacity of the autonomous bus of type m, and Cₐ^{F} and Cₐ^{V} represent the fixed operating cost and marginal operating cost of the autonomous bus, respectively.

5. The optimization method for joint scheduling of manned buses and autonomous buses according to claim 4, wherein in the step 4, the passenger waiting time includes two parts, one part is the time for passengers to wait for a bus which arrives at the stop first after he/she arrives at the stop, and the other part is the further waiting time for passengers who cannot get on the bus due to the limitation of bus capacity; for the first part, assuming that passengers arrive at random, the average waiting time of the passengers is half of the time headway, i.e. ½(d_{v,s}−d_{v-1,s}), and the total arrival number of passengers is λₛ (d_{v,s}−d_{v-1,s}), the waiting time of passengers at this stop when the bus v arrives at the stop s is ½λₛ(d_{v,s}−d_{v-1,s})²; and for the second part, the passenger waiting time is the product of the stranded passenger number ω_{v,s} and the time headway.

6. The optimization method for joint scheduling of manned buses and autonomous buses according to claim 5, wherein in the step 5, the optimization model is:
$$min z = {\sum }_{k ∈ κ} {\sum }_{m ∈ M} {x}_{m k} {f}_{m} + {ρ}_{1} \cdot {\sum }_{v = 1}^{n} {\sum }_{s = 1}^{{n}_{s} - 1} [ \frac{1}{2} {{λ}_{s} ( {d}_{v , s} - {d}_{v - 1 , s} )}^{2} ] + {ρ}_{2} \cdot {\sum }_{v = 1}^{n} {\sum }_{s = 1}^{{n}_{s} - 1} {ω}_{v , s} ( {d}_{v + 1 , s} - {d}_{v , s} ) \\ s . t . \\ Eqs . ( 1 ) \text{-} ( 15 ) \qquad ( 16 )$$
where ρ₁ and ρ₂ respectively represent the cost parameters corresponding to the waiting time of the two parts.

7. The optimization method for joint scheduling of manned buses and autonomous buses according to claim 1, wherein the optimization model is a nonlinear shaping optimization model, and is directly solved by business optimization software Cplex or gurobi.

8. The optimization method for joint scheduling of manned buses and autonomous buses according to claim 2, wherein the optimization model is a nonlinear shaping optimization model, and is directly solved by business optimization software Cplex or gurobi.

9. The optimization method for joint scheduling of manned buses and autonomous buses according to claim 3, wherein the optimization model is a nonlinear shaping optimization model, and is directly solved by business optimization software Cplex or gurobi.

10. The optimization method for joint scheduling of manned buses and autonomous buses according to claim 4, wherein the optimization model is a nonlinear shaping optimization model, and is directly solved by business optimization software Cplex or gurobi.

11. The optimization method for joint scheduling of manned buses and autonomous buses according to claim 5, wherein the optimization model is a nonlinear shaping optimization model, and is directly solved by business optimization software Cplex or gurobi.

12. The optimization method for joint scheduling of manned buses and autonomous buses according to claim 6, wherein the optimization model is a nonlinear shaping optimization model, and is directly solved by business optimization software Cplex or gurobi.
